(19) United States
(12) Patent Application Publication
(10) Pub. No.: US 2015/0149231 A1
(43) Pub. Date: May 28, 2015

(54) System and Method for Auto Detecting and Informing Missing Meeting Attendees to Join a Meeting

(71) Applicant: FUTUREWEI TECHNOLOGIES, INC., Plano, TX (US)

(72) Inventors: Rey Nicolas, San Diego, CA (US); Robert McCarthy, Escondido, CA (US)

(21) Appl. No.: 14/092,651

(22) Filed: Nov. 27, 2013

(51) Int. Cl. G06Q 10/10; H04W 4/02; H04W 4/00

(52) U.S. Cl. CPC G06Q 10/1095; H04W 4/008; H04W 4/02
USPC 705/7.19

(57) ABSTRACT

Embodiments are provided for detecting and handling missing meeting attendees. The embodiments include mechanisms to detect and notify missing attendees to join a meeting, and inform a meeting organizer of the status of missing attendees. The missing attendees are detected using user equipment (UE) and location determining technology. Additionally, UE sensor technology is used to estimate arrival time of expected attendees. A UE of the organizer detects present attendees in a meeting location using a near range wireless connection with UEs of the present attendees. The organizer's UE then detects a missing attendee from the meeting in accordance with a pre-established list of invitees and the detected present attendees, and sends a notification message including a reminder of the meeting to a UE of the missing attendee. The UE of the missing attendee also receives a message to activate a wireless positioning service capability.

### TECHNICAL FIELD

The present invention relates to the field of group meeting management and scheduling, and, in particular embodiments, to a system and method for auto detecting and informing missing meeting attendees to join a meeting.

### BACKGROUND

In the case of in-person meeting events, such as large group meetings at corporate environments or other settings, determining the presence of attendees is beneficial. For example, the meeting may not be started until certain individuals arrive or a number of attendees is reached. Waiting for missing attendees to join the meeting can cause loss of time and unnecessary delays. For example, a missing attendee may forget about the meeting or the meeting's start time, or may not be able to attend the meeting. The delays from waiting for absent attendees can waste valuable time and affect overall meeting efficiency. There is a need for a mechanism to avoid such issues and better detect and handle missing meeting attendees.

### SUMMARY OF THE INVENTION

In accordance with an embodiment, a method implemented by a user equipment (UE) of an organizer of a meeting for detecting missing attendees includes detecting present attendees in a meeting location using a near range wireless connection with UEs of the present attendees. The method then detects a missing attendee from the meeting in accordance with a pre-established list of invitees and the detected present attendees. The method further includes sending a notification message including a reminder of the meeting to a UE of the missing attendee.

In accordance with another embodiment, a UE of an organizer of a meeting configured for detecting missing attendees includes at least one processor and a non-transitory computer readable storage medium storing programming for execution by the at least one processor. The programming includes instructions to detect present attendees in a meeting location using a near range wireless connection with UEs of the present attendees. The programming includes further instructions to detect a missing attendee from the meeting in accordance with a pre-established list of invitees and the detected present attendees. The UE of the organizer is further configured to send a notification message including a reminder of the meeting to a UE of the missing attendee.

In accordance with another embodiment, a method implemented by a UE of an invitee to a meeting includes receiving a message notifying the invitee to activate a wireless positioning service capability on the UE of the invitee. The message is received from a UE of an organizer of the meeting upon failure to detect a near range wireless connection between the UE of the organizer and the UE of the invitee.

In accordance with yet another embodiment, a UE of an invitee to a meeting includes at least one processor and a non-transitory computer readable storage medium storing programming for execution by the at least one processor. The programming includes instructions to receive a message notifying the invitee to activate a wireless positioning service capability on the UE of the invitee. The message is received from a UE of an organizer of the meeting upon failure to detect a near range wireless connection between the UE of the organizer and the UE of the invitee.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a scenario of a group meeting in a physical location;

FIG. 2 illustrates an embodiment method for meeting attendee discovery;

FIG. 3 illustrates an embodiment method for handling a missing meeting attendee;

FIG. 4 illustrates another embodiment method for meeting attendee discovery; and

FIG. 5 is a diagram of an exemplary processing system that can be used to implement various embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Embodiments are provided herein for detecting and handling missing meeting attendees. The embodiments include mechanisms to detect and notify missing attendees to join a meeting, and inform a meeting organizer of the status of missing attendees. The missing attendees are detected using user equipment (UE) and location determining technology. Additionally, UE sensor technology is used to estimate arrival time of expected attendees. Providing such functionality and information reduces meeting wait time and improves efficiency of meetings. The mechanisms herein also promote on-time participation of attendees in meetings.

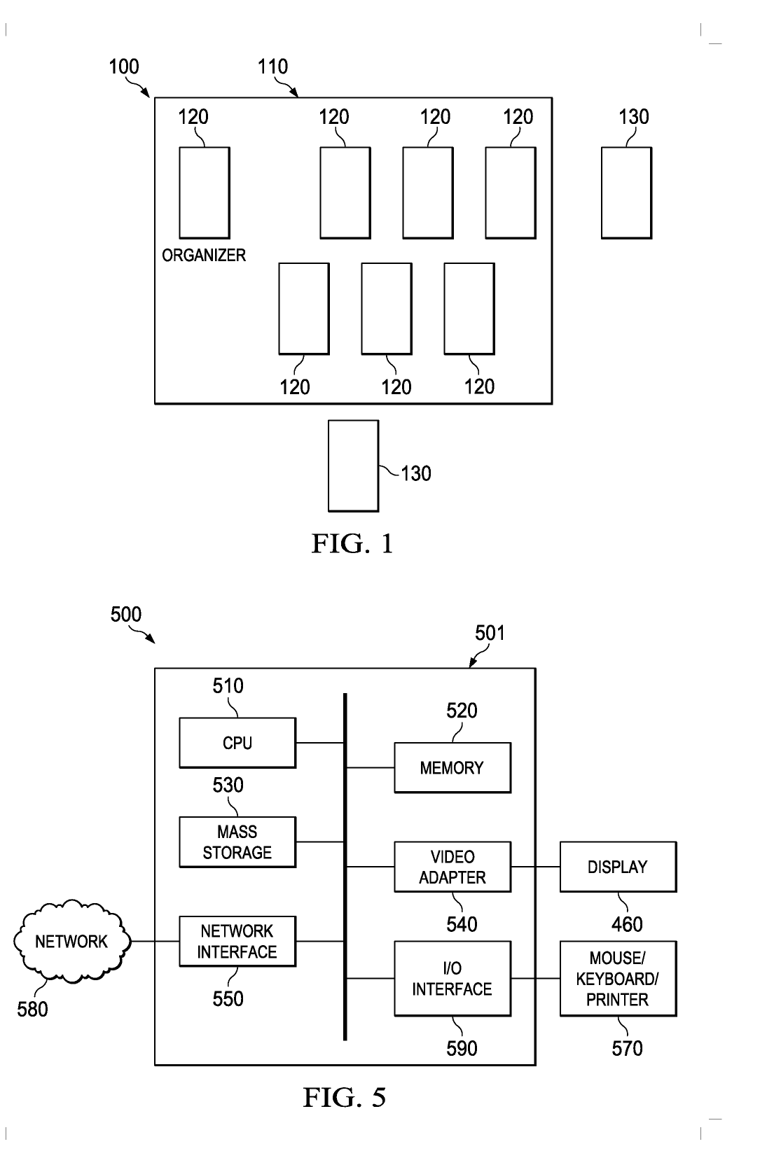

FIG. 1 illustrates a scenario 100 of a group meeting in a physical meeting location 190. The group meeting comprises a plurality of present attendees 120 including an organizer. The present attendees 120 participate in the meeting, whether by attending, observing, presenting, managing, organizing, or performing other meeting tasks. An organizer is one of the present attendees 120 who initially schedules the meeting, for instance by sending out a meeting invitation to a list of invitees (or attendees). The group meeting may have any number of present attendees 120 belonging to the list of invitees. Additionally, the list of attendees or invitees may include any number missing attendees 130 who have not yet joined, prior to or at the meeting start time, the present attendees 120 in the allocated physical meeting location 190. The physical meeting location 190 is any physical structure, space, or location allocated for conducting the meeting. For example, the physical meeting location 190 can be a room, a hall, an auditorium, or any other suitable structure or location for holding a meeting such as an open space equipped for this purpose.

In an embodiment, a system is implemented for obtaining knowledge of missing and present attendees that are scheduled for a meeting, such as in the scenario 100, and notifying the missing attendees of the meeting. The system can further determine whether the missing attendees plan to attend the meeting, and may determine the estimate arrival time of missing attendees. This knowledge is reported to the meeting organizer, and hence may be used to help determining when to start the meeting. The present attendees and the missing attendees are detected using their corresponding UEs and location determining technology, as described below. The UEs include any communication device equipped with connection capability, including for wireless communications. Examples of UEs include smartphones, laptop computers, tablet computers, or other personal computer or mobile devices. The UEs can also provide location and movement information. The UEs' capability includes Bluetooth connectivity, Global Positioning System (GPS) capability, and movement sensors. The capability may also include WiFi (or Wireless Local Access Network (WLAN)) and/or 3GPP cellular connectivity.

The UEs' wireless connection capability can be used to detect corresponding present attendees in the meeting room or location. In an embodiment, the attendees' devices that establish Bluetooth connectivity with each other or with the designated organizer's device, e.g., within the range of the meeting location or room, are detected to identify the corresponding present attendees. In another embodiment, a short range wireless connection, such as a WiFi connection, can be used to detect UEs of present attendees in the meeting room or location. Upon determining the present attendees, the missing attendees can be identified as the remaining attendees from a list of scheduled attendees. The list of scheduled attendees or meeting invitees may be previously established in a meeting invite request by the organizer when scheduling the meeting. Additionally, the missing attendees are identified by means of their positioning/localization information, which can be collected via the missing attendees' UEs. In an embodiment, GPS capability on the UEs is used to obtain such information. GPS capability. Indoor navigation mechanisms can also be used to determine more precise localization of missing attendees, such as in which building section, floor, or room. The indoor navigation may include GPS or similar technology and features to map the location information to a map (e.g., a local area or indoor building map). In another embodiment, a variety of connectivity and/or positioning technologies can be used for detecting that location of missing attendees, e.g., depending on each device's capability.

In addition to the positioning information, the UE's movement sensor technology can also be used to determine the estimate arrival time of a missing or expected attendee and possibly movement direction of the corresponding UE. For example, the missing attendee's smartphone may be equipped with one or more motion sensors such as accelerometer, gyroscope, and/or compass, which can be used to determine the movement speed and direction of a missing attendee's smartphone. When a missing attendee is identified, e.g., at the start time of the meeting or at a predefined time period before the actual start time, the attendee is notified of the meeting start time. The notification can be sent via a Short Message Service (SMS) message (or any other text message service) to the missing attendee's smartphone or cellular phone, for instance from the organizer's smartphone or cellular phone as the sender. In another embodiment, the notification may be sent via email or any other messaging service available on both the missing attendee's and organizer's devices. This may motivate the missing attendee to attend or arrive at the meeting on time. The system may also inquire the missing attendee as to whether he/she will attempt the meeting. Such information can be sent with the estimate arrival time, if available, to the organizer to help in determining when to start the meeting. The inquiry and response can be established via SMS or any suitable texting/messaging means as described above.

In an embodiment, the system above is implemented on the UEs via any application or software suitable for this purpose. For example, a calendar application on the UEs used for scheduling the meeting or another application that communicates with the calendar application is configured to trigger the UE's detection mechanism (connectivity/positioning technology) at the meeting start time or a predefined time, and accordingly perform one or more of the steps above. The steps include notifying the missing attendees of meeting start time, notifying the organizer of missing attendees, inquiring whether a missing attendee will attend, determine expected arrival time of missing attendee, and inform the organizer of expected attendee and estimate arrival time if available.

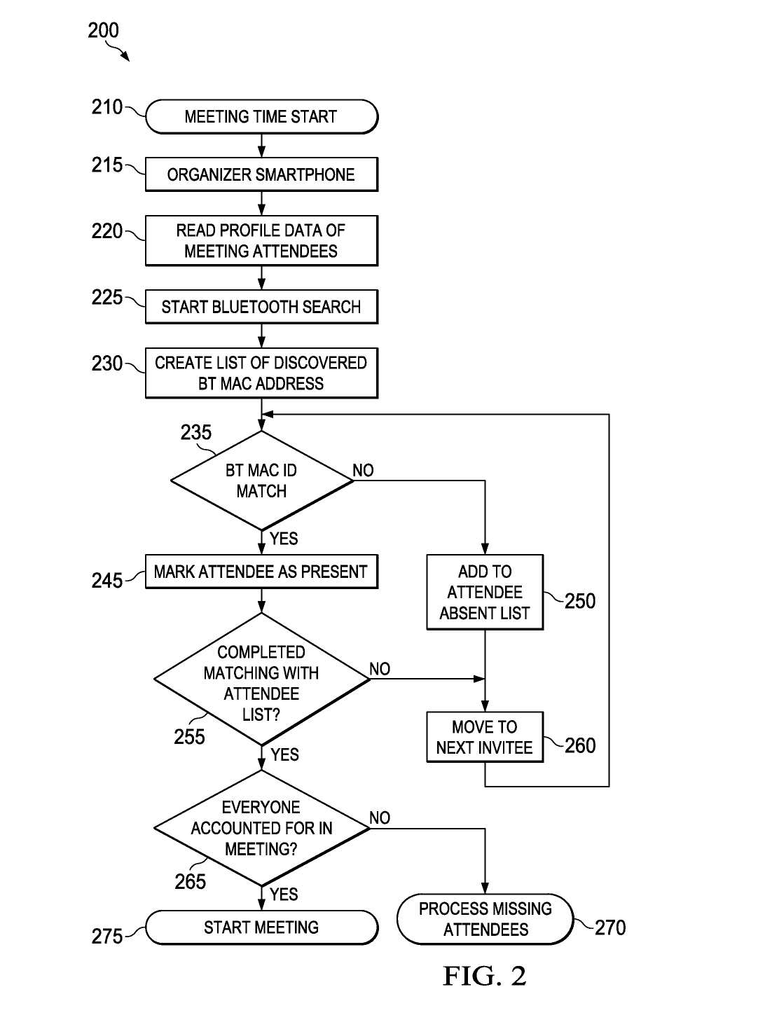

FIG. 2 illustrates an embodiment method 200 for meeting attendee discovery. The method 200 can be implemented on a designated meeting organizer's UE. For instance, the designated meeting organizer's UE is the one that scheduled the meeting or issued the meeting invite request. At step 210, the meeting start time is detected. At step 215, the organizer's smartphone (or other type of UE) is identified, e.g., as the source for scheduling the meeting or sending out the meeting invitation. At step 220, the method 200 reads the profile data of meeting attendees, and accordingly establishes an attendee list. Thus, a list of expected or scheduled attendees is obtained. At step 225, the method 200 starts Bluetooth search to detect devices within range. At step 230, a list of discovered Bluetooth (BT) Media Access Control (MAC) addresses is created for the detected devices.

At step 235, the method 200 determines, for each invitee in the attendee list, if there is a match in the list of discovered MAC address or ID. If a match is not found, then the corresponding attendee is added to a missing attendee list in step 250, and the method proceeds to step 260. At step 260, the next attendee in the list is considered, and the method returns to step 235. Alternatively, if a match is found, then the corresponding attendee is marked as present at step 245, and the method proceeds to step 255. At step 255, the method 200 determines if it completed matching for all the attendees in the attendee list. If this is not true, the method proceeds to step 260. If the condition in step 255 is true, the method 200 proceeds to step 265. At step 265, the method checks if every attendee is accounted for, e.g., marked as present or absent. If all attendees are accounted for, the meeting is started at step 275. However, if there is one or more absent or missing attendees, the method processes the missing attendees at step 270, as described below.

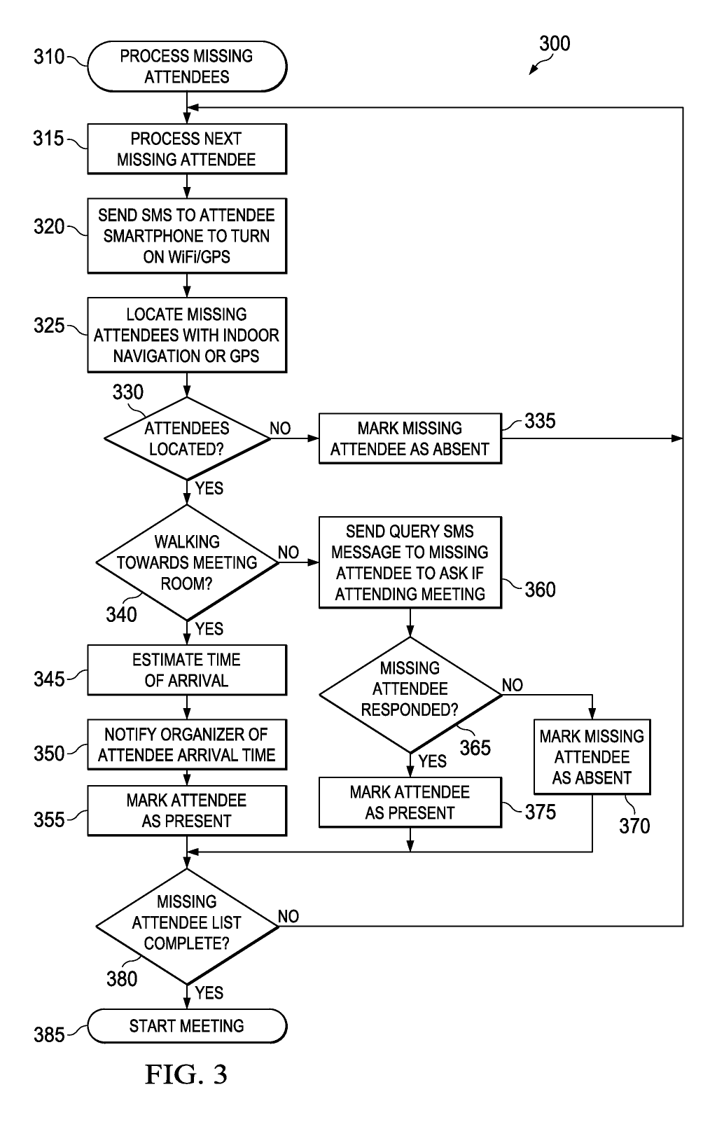

FIG. 3 illustrates an embodiment method 300 for handling a missing meeting attendee. The method 300 can be implemented (on the organizer's UE) in step 270 above. At step 310, the method 300 begins processing the missing attendees, for example, which were determined in method 200. At step 315 of method 300, the next missing attendee (in the list of missing attendees) is processed. At step 320, the method 300 sends a SMS or text message to the missing attendee's smartphone to turn on WiFi/GPS functionality. At step 325, the missing attendees are located using indoor navigation and/or GPS, and possibly WiFi or 3GPP connectivity to enable features of indoor navigation/GPS. The method 300 locates the missing attendee via indoor navigation or GPS, once the attendee turn on WiFi/GPS functionality. For indoor navigation, the detected location of the UE may be mapped to a map of the area where the UE is located.

At step 330, the method 300 determines if the missing attendee is located. If the attendee is not located, the attendee is marked as an absent attendee and the method 300 returns to step 315 to address another missing attendee. If the attendee is located, the method 300 determines at step 340 if the attendee is walking or moving towards the meeting room or location. This determination can be made using the GPS and motion sensor capability from the missing attendee's UE, as described above. If the method 300 determines that the missing attendee is on his/her way to the meeting place, the method estimates the attendee's time of arrival at step 345. Next at step 350, the organizer of the meeting is notified of the arrival (or estimate arrival time) of this attendee, for example via a SMS or other messaging means. At step 355, the attendee is marked as present, and the method proceeds to step 380. Alternatively, if the method 300 determines that the attendee is not walking or moving towards the meeting place, then at step 360, the method sends a query SMS message (or text message) to the missing attendee's UE to ask if the attendee will be attending the meeting. At step 365, the method determines if the missing attendee responded (e.g., positively confirming attendance intention) to the SMS message. If this is not true (e.g., no or a negative response is received), then the missing attendee is marked as absent at step 370. If the missing attendee responds (e.g., positively confirming attendance intention) to the message, then the attendee is marked as present at step 375. The method proceeds after steps 370 or 375 to step 380. At step 380, the method checks if the missing attendee list is completed. If this is true, then the meeting is started at step 385. Otherwise, the method 300 returns to step 315.

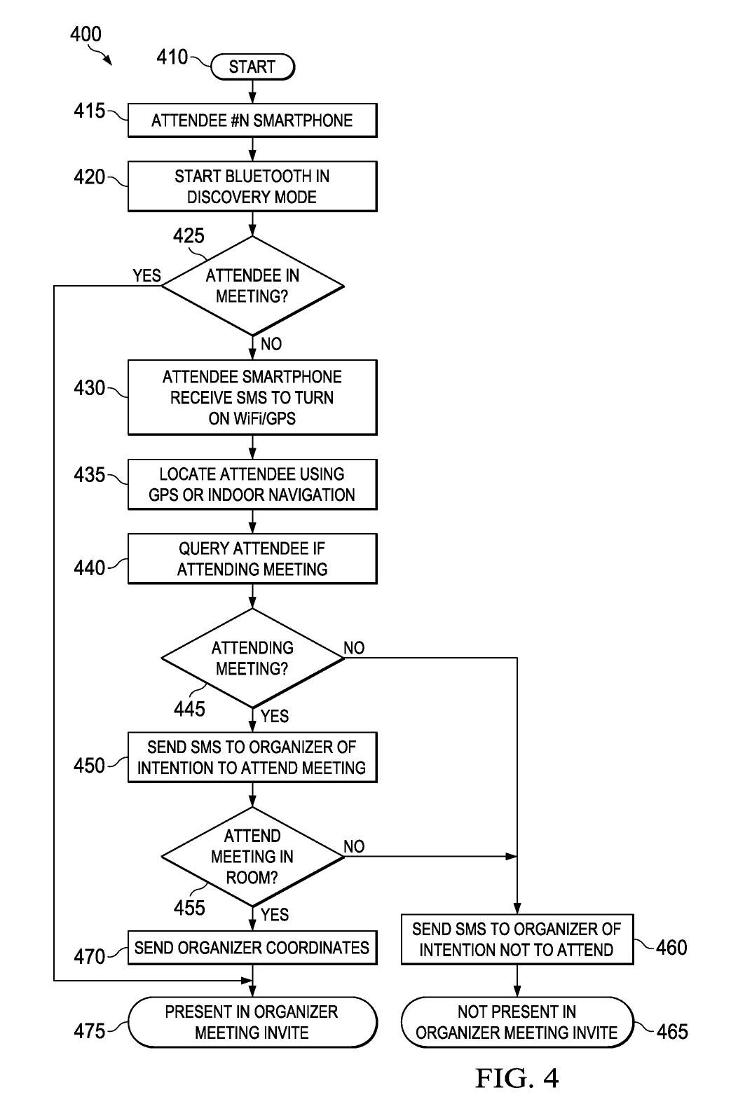

FIG. 4 illustrates an embodiment method 400 for meeting attendee discovery. The method 400 can be implemented on each attendee's UE. At step 410, the attendee number N (N is an integer) UE is considered. At step 420, the method 400 starts Bluetooth in discovery mode on the UE. At step 425, the method determines whether the attendee is at the meeting place, e.g., using Bluetooth as described above. If the attendee is found at the meeting place, the method 400 proceeds to step 475, where the attendee is marked as present, e.g., in the organizer meeting invite request or a calendar application. Otherwise, at step 430, the attendee UE or smartphone receives a SMS message (e.g., from the organizer) to turn on WiFi/GPS capability. At step 435, the attendee is located using GPS or indoor navigation. At step 440, the method queries the attendee, e.g., via SMS, if attending the meeting.

At step 445, the method determines if the attendee is attending the meeting (based on the attendee's response or no/negative response to the query). If not attending, then the method proceeds to step 460, where a SMS message is sent to the organizer to inform the organizer of the attendee not attending. The method 400 then proceeds to step 465, where the attendee is marked as not present in the organizer meeting invite request. Alternatively, if the attendee is attending, then a SMS message is sent to the organizer to inform the organizer of the attendee's intention to attend the meeting. Next, at step 455, the method determines if the attendee is to attend at the designated meeting room or location. If this is true, then the organizer's coordinates or location (e.g., at the meeting room or location) are sent to attendee's UE at step 470, and the method proceeds to step 475 described above. Otherwise, the method performs step 460 described above.

FIG. 5 is a block diagram of an exemplary processing system 500 that can be used to implement various embodiments. The processing system is part of a UE, such as a smartphone, of a meeting scheduled attendee. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system 500 may comprise a processing unit 501 equipped with one or more input/output devices, such as a speaker, microphone, mouse, touchscreen, keypad, keyboard, printer, display, and the like. The processing unit 501 may include a central processing unit (CPU) 510, a memory 520, a mass storage device 530, a video adapter 540, and an Input/Output (I/O) interface 590 connected to a bus. The bus may be one or more of any type of several bus architectures including a memory bus or memory controller, a peripheral bus, a video bus, or the like.

The CPU 510 may comprise any type of electronic data processor. The memory 520 may comprise any type of system memory such as static random access memory (SRAM), dynamic random access memory (DRAM), synchronous DRAM (SDRAM), read-only memory (ROM), a combination thereof, or the like. In an embodiment, the memory 520 may include ROM for use at boot-up, and DRAM for program and data storage for use while executing programs. The mass storage device 530 may comprise any type of storage device configured to store data, programs, and other information and to make the data, programs, and other information accessible via the bus. The mass storage device 530 may comprise, for example, one or more of a solid state drive, hard disk drive, a magnetic disk drive, an optical disk drive, or the like.

The video adapter 540 and the I/O interface 590 provide interfaces to couple external input and output devices to the processing unit. As illustrated, examples of input and output devices include a display 560 coupled to the video adapter 540 and any combination of mouse/keyboard/printer 570 coupled to the I/O interface 590. Other devices may be coupled to the processing unit 501, and additional or fewer interface cards may be utilized. For example, a serial interface card (not shown) may be used to provide a serial interface for a printer.

The processing unit 501 also includes one or more network interfaces 550, which may comprise wired links, such as an Ethernet cable or the like, and/or wireless links to access nodes or one or more networks 580. The network interface 550 allows the processing unit 501 to communicate with remote units via the networks 580. For example, the network interface 550 may provide wireless communication via one or more transmitters/transmit antennas and one or more receivers/receive antennas. In an embodiment, the processing unit 501 is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method implemented by a user equipment (UE) of an organizer of a meeting for detecting missing attendees, the method comprising:
detecting present attendees in a meeting location using a near range wireless connection with UEs of the present attendees;
detecting a missing attendee from the meeting in accordance with a pre-established list of invitees and the detected present attendees; and
sending a notification message including a reminder of the meeting to a UE of the missing attendee.

2. The method of claim 1, wherein the near range wireless connection with the UEs is a Bluetooth connection between the UE of the organizer and the UEs of the present attendees.

3. The method of claim 1 further comprising sending a second notification message to the UE of the missing attendee, the second notification message notifying the missing attendee to activate a wireless positioning service capability on the UE of the missing attendee.

4. The method of claim 3, wherein the wireless positioning service capability includes at least one of Global Positioning System (GPS) and indoor navigation capability.

5. The method of claim 3 further comprising:
determining a current location of the missing attendee via the wireless positioning service capability of the UE of the missing attendee;
estimating an arrival time of the missing attendee via a movement sensor on the UE of the missing attendee; and
notifying the organizer of the estimated arrival time.

6. The method of claim 5, wherein the arrival time of the missing attendee is estimated upon detecting the missing attendee moving towards the meeting room according to the current location of the missing attendee.

7. The method of claim 3 further comprising:
determining a current location of the missing attendee via the wireless positioning service capability of the UE of the missing attendee;
sending a query message to the UE of the missing attendee, the query message inquiring whether the missing attendee intends to attend the meeting; and
notifying the organizer of whether the missing attendee intends to attend the meeting.

8. The method of claim 7, wherein the query message is sent to the UE of the missing attendee upon detecting the missing attendee not moving towards the meeting room according to the current location of the missing attendee.

9. The method of claim 7, wherein notifying the organizer of whether the missing attendee intends to attend the meeting includes one of notifying the organizer of the missing attendee attending the meeting upon receiving from the missing attendee a positive response to the query, and notifying the organizer of the missing attendee not attempting the meeting upon receiving from the missing attendee a negative response or no response to the query.

10. The method of claim 7, wherein the query message is sent using a Short Message Service (SMS) from the UE of the organizer to the UE of the missing attendee.

11. The method of claim 3 further comprising notifying the organizer of absence of the missing attendee upon failure to locate the missing attendee via the wireless positioning service capability of the UE of the missing attendee.

12. The method of claim 1, wherein detecting the missing attendee from the meeting in accordance with the pre-established list of invitees and the detected present attendees includes:
creating a list of the detected present attendees; and
adding, to a list of missing attendees, each invitee in the list of invitees without a match in the list of the detected present attendees.

13. The method of claim 1, wherein the notification message including the reminder of the meeting is sent using a Short Message Service (SMS) from the UE of the organizer to the UE of the missing attendee.

14. A user equipment (UE) of an organizer of a meeting configured for detecting missing attendees, the UE comprising:
at least one processor; and
a non-transitory computer readable storage medium storing programming for execution by the at least one processor, the programming including instructions to:
detect present attendees in a meeting location using a near range wireless connection with UEs of the present attendees;
detect a missing attendee from the meeting in accordance with a pre-established list of invitees and the detected present attendees; and
send a notification message including a reminder of the meeting to a UE of the missing attendee.

15. The UE of claim 14, wherein the near range wireless connection with the UEs is a Bluetooth connection between the UE of the organizer and the UEs of the present attendees.

16. The UE of claim 14, wherein the programming includes further instructions to send a second notification message to the UE of the missing attendee, the second notification message notifying the missing attendee to activate a wireless positioning service capability on the UE of the missing attendee.

17. The UE of claim 16, wherein the wireless positioning service capability includes at least one of Global Positioning System (GPS) and indoor navigation capability.

18. The UE of claim 16, wherein the programming includes further instructions to:
determine a current location of the missing attendee via the wireless positioning service capability of the UE of the missing attendee;
estimate an arrival time of the missing attendee via a movement sensor on the UE of the missing attendee; and
notify the organizer of the estimated arrival time.

19. The UE of claim 16, wherein the programming includes further instructions to:
determine a current location of the missing attendee via the wireless positioning service capability of the UE of the missing attendee;
send a query message to the UE of the missing attendee, the query message inquiring whether the missing attendee intends to attend the meeting; and
notify the organizer of whether the missing attendee intends to attend the meeting.

20. The UE of claim 14, wherein the notification message is sent using a Short Message Service (SMS) from the UE of the organizer to the UE of the missing attendee.

21. A method implemented by a user equipment (UE) of an invitee to a meeting, the method comprising:
receiving a message notifying the invitee to activate a wireless positioning service capability on the UE of the invitee, wherein the message is received from a UE of an organizer of the meeting upon failure to detect a near range wireless connection between the UE of the organizer and the UE of the invitee.

22. The method of claim 21, wherein the wireless positioning service capability includes at least one of Global Positioning System (GPS) and indoor navigation capability.

23. The method of claim 21 further comprising:
determining a current location of the invitee using the wireless positioning service capability;
estimating an arrival time of the invitee using a movement sensor on the UE of the invitee; and
notifying the organizer of the estimated arrival time.

24. The method of claim 21 further comprising:
receiving a query message from the UE of the organizer, the query message inquiring whether the invitee intends to attend the meeting; and
sending a response message notifying the organizer of the invitee attending or not attending the meeting.

25. The method of claim 24 further comprising upon responding to indicate attendance of the meeting, receiving location information of the organizer.

26. The method of claim 21, wherein the message is received using a Short Message Service (SMS) from the UE of the organizer.

27. The method of claim 21, wherein the near range wireless connection is a Bluetooth connection.

28. A user equipment (UE) of an invitee to a meeting, the UE comprising:
at least one processor; and
a non-transitory computer readable storage medium storing programming for execution by the at least one processor, the programming including instructions to receive a message notifying the invitee to activate a wireless positioning service capability on the UE of the invitee, the message received from a UE of an organizer of the meeting upon failure to detect a near range wireless connection between the UE of the organizer and the UE of the invitee.

29. The UE of claim 28, wherein the wireless positioning service capability includes at least one of Global Positioning System (GPS) and indoor navigation capability.

30. The UE of claim 28, wherein the programming includes further instructions to:
determine a current location of the invitee using the wireless positioning service capability;
estimate an arrival time of the invitee using a movement sensor on the UE of the invitee; and
notify the organizer of the estimated arrival time.

31. The UE of claim 28, wherein the programming includes further instructions to:
receive a query message from the UE of the organizer, the query message inquiring whether the invitee intends to attend the meeting; and
sending a response message notifying the organizer of the invitee attending or not attending the meeting according to the response.

32. The UE of claim 28, wherein the message is received using a Short Message Service (SMS) from the UE of the organizer.
